(19) United States
(12) Patent Application Publication
(10) Pub. No.: US 2014/0179158 A1
(43) Pub. Date: Jun. 26, 2014

(54) Adapter Arrangement

(71) Applicant: WEIDMUELLER INTERFACE GMBH & CO. KG, DETMOLD (DE)

(72) Inventors: Christian Heggemann, Detmold (DE); Hans Schlingmann, Horn-Bad Meinberg (DE)

(73) Assignee: WEIDMUELLER INTERFACE GMBH & CO. KG, Detmold (DE)

(21) Appl. No.: 14/106,924

(22) Filed: Dec. 16, 2013

(30) Foreign Application Priority Data
Dec. 20, 2012 (DE) 202012104999.6

(51) Int. Cl. H01R 13/514

(52) U.S. Cl. CPC H01R 13/514
USPC 439/556

(57) ABSTRACT

A first adapter arrangement includes a housing having a sealing end supporting the housing in a vertical wall opening of a casing containing an electronics device, and a connecting end extending externally of the casing for connection with the housing of a companion adapter arrangement. A pair of resilient generally-annular longitudinally-spaced seal members are mounted concentrically about the adapter housing sealing portion for sealing the space between the adapter housing outer surface and the adjacent surface of the casing wall opening. An electrical connector mounted in a through passage contained in the adapter housing includes a conductor contact end connected with the conductors of the electrical device, and a connector contact end adapted for connection with the corresponding contacts of a companion second adapter arrangement. A fastening device serves to connect together the adjacent ends of the adapter housings of the first and second arrangements.

### REFERENCE TO RELATED APPLICATIONS

This application is based on and claims priority of the German application No. DE 20 2012 104 999.6 filed Dec. 20, 2012.

### FIELD OF THE INVENTION

A first adapter arrangement includes a housing having a sealing end supporting the housing in a vertical wall opening of a casing containing an electronics device, and a connecting end extending externally of the casing for connection with the housing of a companion adapter arrangement. A pair of resilient generally-annular longitudinally-spaced seal members are mounted concentrically about the adapter housing sealing portion for sealing the space between the adapter housing outer surface and the adjacent surface of the casing wall opening. An electrical connector mounted in a through passage contained in the adapter housing, and a fastening arrangement serves to connect together the adjacent ends of the adapter housings of the first and second arrangements.

### DESCRIPTION OF RELATED ART

Electronics device frequently must be arranged in spaces exposed to dust, moisture, EMV and other contaminants. Such spaces are outdoor installations, production lines and/or the surroundings of power installations, for example. The present invention was developed to provide an electronics assembly which allows multiple electronics housings to be flexibly connected in series, and ensures very good dust, moisture and contaminant protection.

### SUMMARY OF THE INVENTION

Accordingly, a primary object of the invention is to provide a first adapter arrangement including a housing having a sealing end supporting the housing in a vertical wall opening of a casing containing an electronics device, and a connecting end extending externally of the casing for connection with the housing of a companion adapter arrangement, a pair of resilient generally-annular longitudinally-spaced seal members being mounted concentrically about the adapter housing sealing portion for sealing the space between the adapter housing outer surface and the adjacent surface of the casing wall opening. An electrical connector mounted in a through passage contained in the adapter housing includes a conductor contact end connected with the conductors of the electrical device, and a connector contact end adapted for connection with the corresponding contacts of a companion second adapter arrangement.

According to a further object, a fastening assembly is provided that connects together the adjacent ends of the adapter housings of the first and second arrangements.

A further object is to provide an adapter arrangement for connecting electrical lines to an electronics housing. The adapter system comprises an adapter housing, which has an interior space and a respective opening on two mutually opposing end faces, and a plug connector, which is arranged in the interior space of the adapter housing and can be accessed through the respective openings. It is preferable that the adapter housing comprises a connecting region having an attachment means for attaching a corresponding second adapter system, and a sealing region having two sealing rings for the sealing arrangement in the electronics housing. The adapter system can be used to connect a cable and/or a series connected electronics housings.

So as to ensure the necessary dust, moisture and/or EMV protection, the sealing rings are preferably arranged behind one another in an extension direction of the adapter housing. Preferably one or both sealing rings are either inserted into the adapter housing so that they can be flexibly exchanged, or they are embedded therein in foam so that they are connected in a captive manner to the adapter housing. In a preferred embodiment, they are produced from differing materials. It is preferred that one of the sealing rings is designed as an EMV protection, wherein the other of the two sealing rings is designed as a dust and moisture protection, or that both sealing rings are designed as dust and moisture protections. Arranging the two sealing rings behind one another not only has the advantage of flexible adaptability to dust, moisture and/or EMV requirements, but also ensures better protection in this regard in a higher protection category.

Preferably a projection and a bracket are provided as the attachment means. It is preferred that the bracket can be rotated about a rotational axis, so that it can be rotated from a basic state into an attachment state. The bracket of a first adapter system can thus be locked to the ridge of a second adapter system.

The plug connector preferably has a connecting side and a contact side, wherein the connecting side can be accessed from the second opening of the adapter housing, and wherein the contact side can be accessed from the first opening of the adapter housing. It is preferable for this purpose that the connecting side is designed as a plug and/or socket. A second plug connector having a complimentary design can thus be connected to the plug connector, and in particular be inserted therein. Attachment means for electrical lines are preferably provided on the contact side, such as cable lugs, so that the electrical lines can be quickly connected.

Moreover, the plug connector is preferably detachably arranged in the adapter housing, in particular clamped, latched or screwed. The plug connector thus can be exchanged or replaced by a differently designed plug connector.

So as to ensure sealing also in the interior space of the adapter housing, the plug connector likewise preferably comprises a first interior space seal, whereby it is arranged in a sealed relation in the adapter housing. In addition or as an alternative, the adapter housing preferably has a second interior space seal in the interior space. In this way dust, moisture and/or EMV cannot penetrate into an electronics housing, not even through the interior space of the adapter housing.

Another object is to provide an adapter assembly comprising two such adapter systems. It is preferable for the adapter systems to be designed so as to complement to each other. The adapter systems are preferably plugged together or into each other. It is particularly preferred for the first adapter system to comprise a first attachment means and a first plug connector, and for the second adapter system to comprise a second attachment means and a second plug connector. It is still more particularly preferred for the first attachment means to be designed to complement the second attachment means, and for the first plug connector to be designed to complement the second plug connector. The adapter systems can thus be arranged behind one another and attached to one another.

The first adapter system preferably comprises a projection as the first part of the attachment means, wherein the second adapter system likewise preferably comprises a bracket as the second part of the attachment means. The bracket can preferably be pivoted from a basic released state about a pivot axis into a locked attachment state. In the locked attachment state, the bracket preferably engages the projection when the adapter systems are plugged into each other, so that the two adapter systems are detachably attached to each other.

Still another object is to provide an electronics assembly comprising an electronics housing and such an adapter system or such an adapter assembly. An electronic system is preferably arranged in the electronics housing. It is likewise preferable if the electronics housing can be accessed from a cover side. The housing can preferably be closed by a cover or a cover component. The sealing rings are preferably designed to have a closed circumference.

It is preferable for the adapter assembly to be insertable into a receiving portion of the electronics housing when the electronics housing is open, so that the sealing region of the adapter housing is arranged in the receiving portion. The insertion from the cover side is possible in a very simple and quick manner.

The sealing rings are particularly preferably seated in a sealed manner against the closed electronics housing and against the cover or cover component when the adapter assembly is inserted into the receiving portion. The closed electronics assembly is thus sealed very well against dust, moisture and/or EMV.

In an electronics assembly comprising an adapter assembly, it is preferable for both adapter systems to be inserted into a respective receiving portion of an electronics housing so that the electronics housings are connected in series.

### BRIEF DESCRIPTION OF THE DRAWINGS

Other objects and advantages of the invention will become apparent from a study of the following specification, when viewed in the light of the accompanying drawing, in which:

FIG. 1 is a perspective view of a first adapter arrangement, and FIG. 1b is a corresponding view of a companion adapter arrangement;

FIGS. 1c and 1d are exploded views of the devices of FIGS. 1a and 1b, respectively;

FIGS. 2a-2c are left end perspective, right end perspective, and exploded views, respectively, of an electronics device assembly including the adapter arrangements of

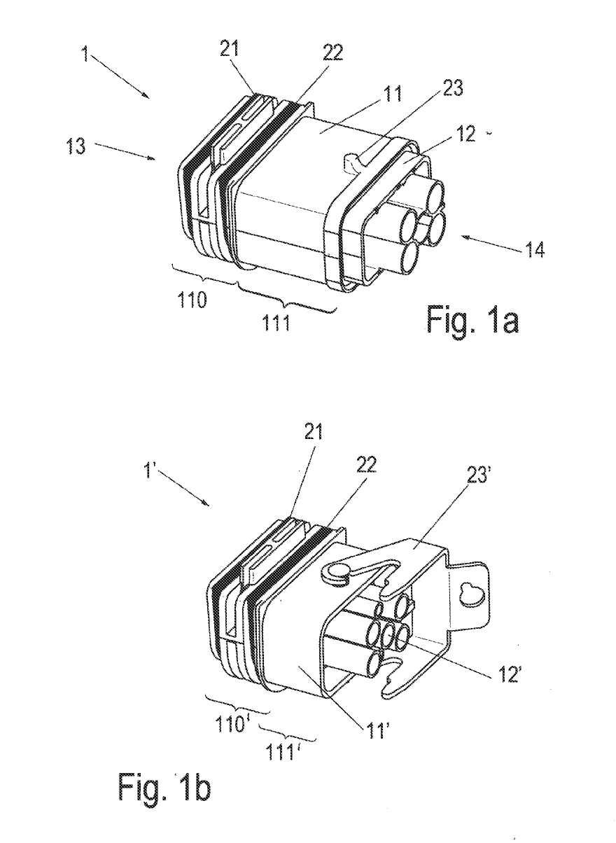

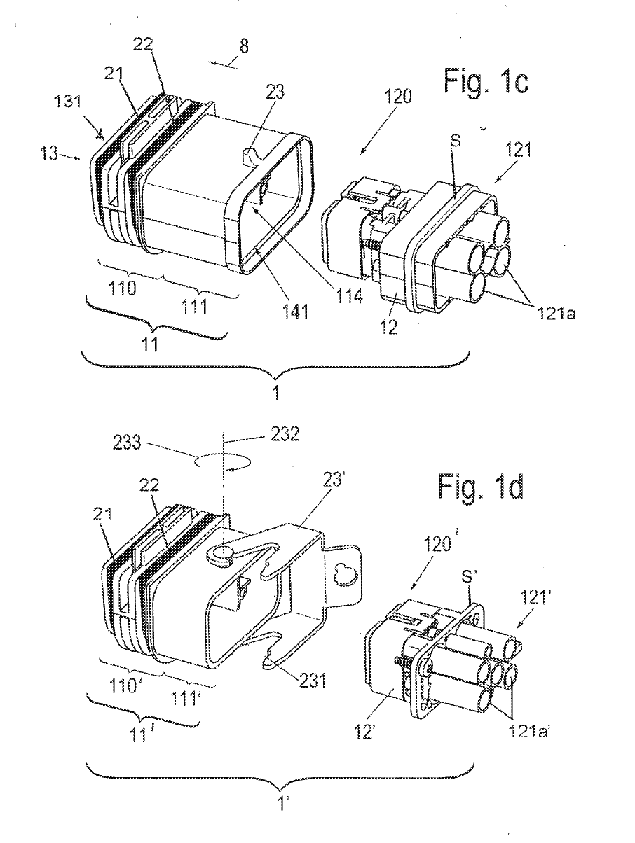

FIGS. 1a and 1b;

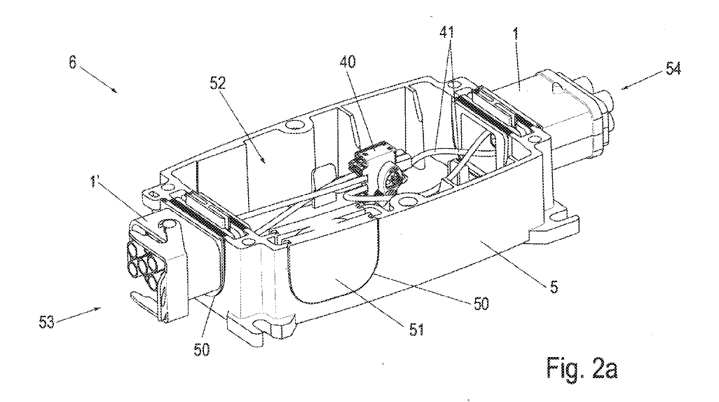

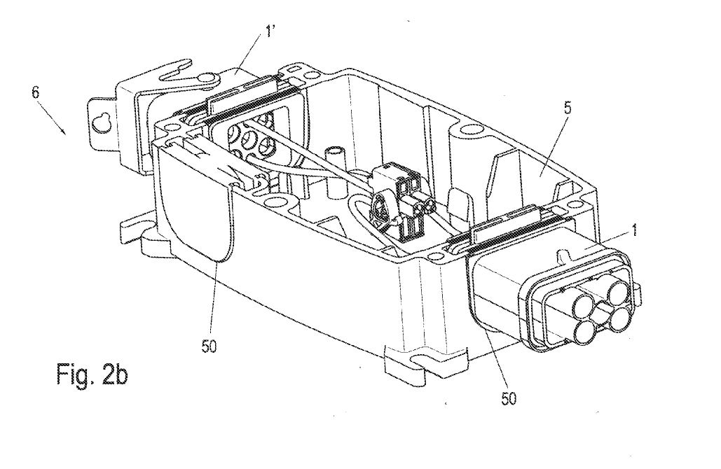

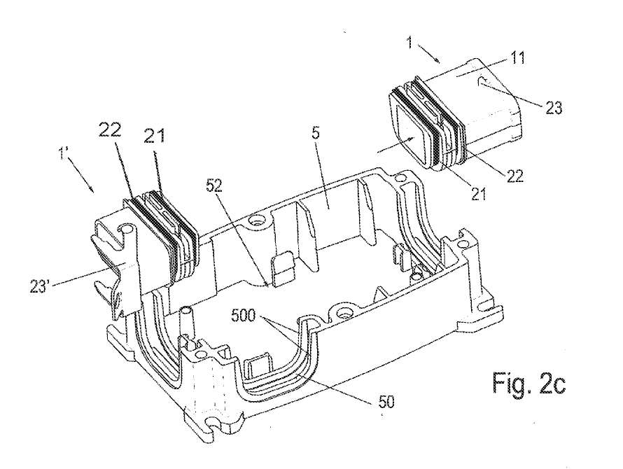

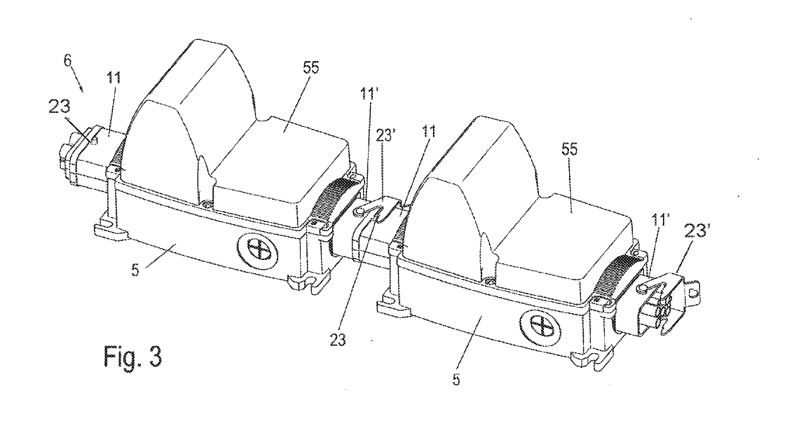

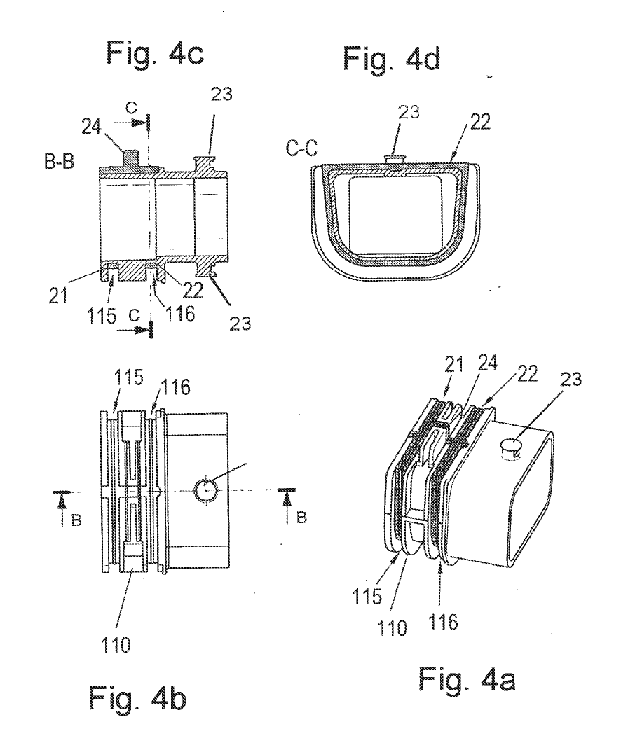

FIG. 3 is a perspective view of two of the electronics devices of FIGS. 2a-2c in a covered, assembled condition;

FIG. 4a is a perspective view of a modification of the adapter housing of FIG. 1a;

FIG. 4b is a top view of the apparatus of FIG. 4a;

FIG. 4c is a sectional view taken along line B-B of FIG. 4b; and

FIG. 4d is a sectional view taken along line C-C of FIG. 4a.

### DETAILED DESCRIPTION OF THE INVENTION

Referring first more particularly to FIGS. 1a and 1c, the adapter arrangement 1 includes a hollow adapter housing 11 having first and second ends 13 and 14, said housing containing a through passage 114 having first and second end openings 131 and 141. At its first end, the adapter housing 11 has a sealing region 110 provided with two generally-annular concentrically-mounted longitudinally spaced resilient seal members 21 and 22, and at its second end the adapter housing has a connecting region 111 provided with vertical upper and lower projections 23 that define a first fastening part. Removably arranged in the through passage 141 is a connector 12 having a conductor contact end 120 having plurality of conductor contacts connected with the conductors 41 of an electrical device 40 (FIG. 2a), and a connection contact end 121 having a plurality of female socket contacts 121a.

Similarly, the companion adapter arrangement 1′ of FIGS. 1b and 1d includes an adapter housing 11′ having a first end with a sealing region 110′ provided with tow longitudinally-spaced seal members 21 and 22, and a second end provided with a connection region 111′ provided with a locking bracket member 23′ that defines a second locking part. The seal members 21, 22 are provided behind one another in an extension direction 8 of the adapter housing 11. They can be produced from the same material or from differing materials. Moreover, they can be inserted into the sealing region 110, or be integrally embedded therein in foam.

The locking bracket 23′ is connected with the adapter housing 11′ for pivotal movement about the vertical pivot axis 232 in the direction 233 from the illustrated released position and toward a locked position (FIG. 3) in which the upper and lower locking projections 23 extend within the upper and lower locking slots 231 contained in the locking bracket 23′. Removably mounted in the through passage contained in the second adapter body 11′ is an electrical connector 12′ having a conductor contact end 120′ provided with a plurality of conductor contacts connected with the conductors of the 41 of the electrical device 40 (FIG. 2a), and a connection contact end 121′ provided with a plurality of male pin contacts 121a′. The connector devices are provided with resilient seal members S and S′ that engage the adjacent surfaces of the associated adapter through passages 114 and 114′, respectively. Each plug connector 12, 12′ is detachably arranged within the associated adapter housing 11, 11′. For example, it is clamped to, engaged by latch means on, or screwed into the associated adapter housing. The conductor contacts of the connectors are connected with the associated conductors 41 of the electronics device 40 by soldering, screw means, or resilient means.

Referring to FIG. 2, the electronics assembly 6 includes a rectangular open-toped casing or housing 5 provided with two adapter arrangements systems 1, 1′ which are arranged in openings 50 contained in opposing casing end wall 53 and 54, respectively. The adapter arrangements 1, 1′ are interchangeably inserted into the receiving openings 50. In addition, a side wall receiving opening 50 is provided, into which a receiving portion a dummy closure member 51 is inserted instead of an adapter system 1, 1′.

The electronics casing 5 is open-topped so that it can be accessed from above. The casing chamber may be closed by a cover member 55, as shown in FIG. 3. When the chamber within electronics casing 5 is open, the adapter assemblies 1, 1′ can be inserted into a respective receiving openings or grooves 50 of the electronics casing 5 from the upper side so that the respective sealing region of the adapter housing is arranged in the receiving portion. So as to prevent dust, moisture and/or EMC from penetrating the space between the adapter housing and the adjacent wall opening surface, the electronics casing 5 is designed to be double-walled (FIG. 2c) in the region of the receiving portions 50, wherein each of the sealing rings 21, 22 arranged in the sealing region 120 ensures sealing on one of the two casing walls or ribs 500. When the electronics casing 5 is closed, the sealing rings 21, 22 thus are seated in compressed against a respective casing wall 500.

An electronic system 40 is arranged in the housing interior space 52 of the electronics casing 5. The electronic system 40 is connected via electrical lines 41 to electrical contacts (not shown) on the contact side 120 of the plug and socket connectors 12, 12, which can each be accessed from the first opening 131.

In FIG. 3, two electronics assemblies 6 according to FIG. 2 are connected in series in end-to-end relation. Two mutually complementary adapter systems 1 and 1′ are plugged together to form an adapter assembly. In this adapter assembly, the female socket connector 12 of the first adapter system 1 and the male pin connector 12′ of the second adapter system 1 are thus designed to complement each other so that they can be plugged together. In addition, the first attachment means 23 of the first adapter system 1, which is designed as a projection, and the attachment means 23′ of the second adapter system 1′, which is designed as a bracket, serve to complement each other. Accordingly, the bracket is shown here in the attachment state, in which it is locked to the projection.

In this illustration, the electronics casings 5 are each closed by a cover component 55. Because of the two sealing rings 21, 22 provided in the sealing region 110 of the adapter system 1, 1′, the interior space 52 of the electronics housing 5, or an electronic system 40 arranged there, is protected well from the penetration of dust, moisture and/or EMV.

According to FIGS. 4a-d, the sealing rings 21, 22 of an alternative adapter housing or plug connector housing system (which here is shown without internal plug connectors) are integrally connected together as one piece to each other via a bridging connection 24, which here is oriented transversely relative to the planes thereof and which engages in a groove for fixation. It is also possible to use a two-component production method so as to configure the sealing rings differently from each other. The sealing rings can be inserted into or molded onto the housing.

In all of the exemplary embodiments, the sealing rings 21, 22 can be inserted or molded into peripheral grooves 115, 116 that are open to the outside in the sealing region 110. In order to improve the sealing action, they can each also be provided with a small radial outer circumferential rib.

While in accordance with the provisions of the Patent Statutes the preferred forms and embodiments of the invention have been illustrated and described, it will be apparent to those skilled in the art that changes may be made without deviating from the invention described above.

What is claimed is:

1. A first adapter arrangement (1, 1′) for supporting a connector (12, 12′) in an opening (50) contained in the wall of a first electronics device casing (5), comprising:
(a) an adapter housing (11, 11′) having a first sealing end (13) and a second connecting end (14), said adapter housing containing a through passage (114) terminating in first (131) and second (141) openings at said adapter housing first and second ends, respectively, said adapter housing first sealing end being operable to support said adapter housing in a first recess (50) contained in a vertical wall of the electronics device casing such that said adapter housing second connecting end extends outwardly from the electronics device casing;
(b) an electrical connector (12, 12′) mounted in said adapter housing passage, respectively, said connector having a contact end (120, 120′) communicating with said housing chamber, said contact end including conductor contacts adapted for connection with conductors associated with the electronics device, and a connection end (121, 121′) having connection contacts adapted for connection with corresponding connector contacts of a companion adapter housing;
(c) a fastening arrangement (23, 23′) operable to fasten said adapter housing second end with the end of a companion adapter housing; and
(d) sealing means mounted on said adapter housing first end for sealing the space between the adjacent surfaces of said adapter housing sealing end and the casing wall recess, said sealing means including a pair of longitudinally-spaced resilient annular seal members (21 and 22) mounted concentrically about said adapter housing first end.

2. An adapter arrangement as defined in claim 1, wherein said sealing means includes at least one longitudinally-extending bridge portion (24) integrally connected between said seal members.

3. An adapter arrangement as defined in claim 1, wherein said electrical connector is removably mounted in said adapter housing, and further including second sealing means (S) for sealing the space between said electrical connector and the wall surface of said adapter housing through passage.

4. An adapter arrangement as defined in claim 1, and further including:
(e) a rectangular open-topped first electronics casing (5) having a horizontal bottom wall, and pairs of vertical side and end walls that cooperate with said bottom wall to define a chamber (52);
(f) an electronics device (40) arranged in said first casing chamber, said electrical device including a plurality of electrical conductors (41); and
(g) a cover member (55) connected with said electronics casing to close said first casing chamber.

5. An adapter arrangement as defined in claim 5, wherein said casing wall opening includes a wall surface provided with two longitudinally-spaced ribs (500) arranged for sealing engagement with said seal members, respectively.

6. An adapter arrangement as defined in claim 4, wherein;
(h) said first casing vertical walls contain a second opening in which is mounted a second adapter arrangement, the connector contacts of one (1′) of said first and second adapter arrangements being male pin contacts, and the connector contacts of the other one (1) of said first and second adapter arrangements being female socket contacts,

6. An adapter arrangement as defined in claim 6, and further including a second electronics casing including first and second adapter arrangements adapted for engagement with corresponding second and first adapter arrangements of said first electronics casing, respectively; and further wherein said fastening means includes an external locking projection (23) on one of the adapter arrangements of said first electronics casing, and a pivotally mounted bracket (23′) on the companion adapter arrangement of the second electronics casing, said bracket being pivotally displaceable between a released position spaced from said locking projection, and a locked position in which said locking projection extends in locking engagement within a locking recess (231) contained in said bracket.
